(19) United States
(12) Patent Application Publication
(10) Pub. No.: US 2011/0037431 A1
(43) Pub. Date: Feb. 17, 2011

(54) BATTERY CHARGER FOR A PORTABLE RADIO

(75) Inventor: Blair Michael MACKLE, Christchurch (NZ)

Correspondence Address: DENNISON, SCHULTZ & MACDONALD, 1727 KING STREET, SUITE 105, ALEXANDRIA, VA, 22314, US

(73) Assignee: TAIT ELECTRONICS LIMITED, Christchurch (NZ)

(21) Appl. No.: 12/856,696

(22) Filed: Aug. 16, 2010

Related U.S. Application Data
(60) Provisional application No. 61/236,663, filed on Aug. 25, 2009.

(30) Foreign Application Priority Data
Aug. 14, 2009 (NZ) 579051

(51) Int. Cl. H02J 7/00

(52) U.S. Cl. 320/114

(57) ABSTRACT

A battery charger for a portable radio having a cradle which holds and charges a radio with a battery attached, or optionally holds and charges the battery alone. The cradle is typically mounted in a vehicle. A lock element is provided in the cradle to engage the battery and is operated by a lock actuator and a release actuator. The lock actuator is displaced when the radio or battery is pushed into the cradle by a user. The release actuator may be displaced by the user to disengage the lock from the battery.

### BACKGROUND TO THE INVENTION

This invention relates to a battery charger for a portable radio, particularly a charger which is adapted for use in a vehicle.

A wide range of chargers are available for hand portable radios, cell phones and other portable electronic devices. When designed for use in a vehicle they are typically also required to hold the device against sudden movements, and should provide the user with a convenient mechanism for locking and release.

The chargers are often manufactured as a cradle which holds the device with battery attached, and connects the battery to a charging circuit which is powered from the vehicle. The user simply places the radio in the cradle to charge the battery. In the case of a portable radio, the charger may be able to hold a battery alone, for convenience in providing the user with a spare.

In this specification the term “radio” generally refers to a radio including a battery, and the term “battery/radio” refers to the battery alone or when attached to the radio.

### SUMMARY OF THE INVENTION

It is an object of the invention to provide an improved battery charger for hand portable radios, or at least to provide an alternative to existing chargers.

In one aspect the invention may be said to reside in a battery charger for a portable radio, having a cradle which receives the battery alone or attached to the radio. A lock actuator is provided in the cradle and is displaced when the battery/radio is pushed into the cradle by a user. A lock is also provided in the cradle to engage the battery/radio as the lock actuator is displaced. A release actuator is also provided and is displaced by the user to disengage the lock from the battery/radio for removal of the battery/radio from the cradle.

Preferably the locking actuator includes a foot which is biased upwards in the cradle and onto which the base of the battery/radio is urged downwards by the user. The locking actuator also includes a portion which restrains the lock until the locking actuator is displaced by the base of the battery/radio.

Preferably the locking latch is biased transversely in the cradle and is released to engage the battery/radio by downwards displacement of the locking actuator. In one embodiment the lock is formed by a pair of arms which engage recesses in the battery. In another embodiment the lock is formed by a pair of pins mounted separately in the cradle.

Preferably the release actuator is biased upwards in the cradle and urges the locking latch transversely away from the battery/radio when pushed downwards by the user. The release actuator may also include a pair of cam surfaces which engage corresponding surfaces on the locking latch to urge the latch away from the battery/radio.

The charger contains an electrical circuit and electrical contacts through which the battery can be charged. Fixtures may be included for mounting the cradle in a vehicle.

### LIST OF FIGURES

Preferred embodiments of the invention will be described with reference to the accompanying drawings, of which:

FIG. 1 is a perspective view of a first embodiment of a charger for a hand portable radio,

FIG. 2 is an exploded view showing main components of the first embodiment,

FIGS. 3a, b, c are vertical sections through the charger in empty, radio locked and radio released configurations,

FIGS. 4a, b, c are horizontal sections through the charger corresponding to FIGS. 3a, b, c,

FIGS. 5a, b are vertical and horizontal sections showing the locked configuration with battery only,

FIG. 6 is a vertical section showing electrical contacts in the radio locked configuration,

FIG. 7 is an exploded view showing main components of a second embodiment of the charger,

FIGS. 8a, b, c are vertical sections through the second charger in empty, radio locked and radio released configurations, and

FIGS. 9a, b, c are horizontal sections through the second charger corresponding to FIGS. 8a, b, c.

### DESCRIPTION OF THE PREFERRED EMBODIMENTS

It will be appreciated that the invention may be implemented in a variety of ways for a range of different radios and batteries. The embodiments described here are given by way of example only.

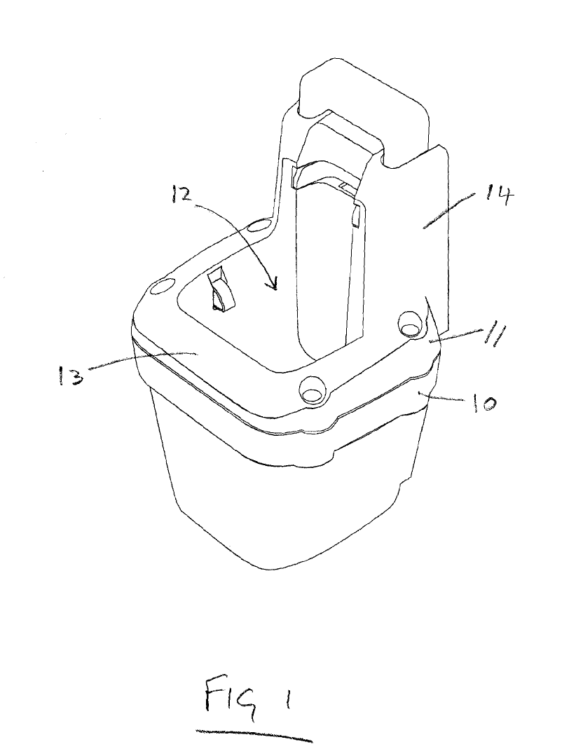

FIG. 1 shows a battery charger for the first embodiment of a hand portable radio, having a cradle formed by a lower portion 10 and an upper portion 11. These portions are typically made from moulded plastic and fastened together by screws, although a range of options might be considered. The upper portion includes a recess 12 with a rim 13, which receives the base of the radio, or the battery alone, and a rear support 14 which contains all or part of a lock and release mechanism for a rear part of the radio or battery. The lower portion forms a shell around part of the upper portion.

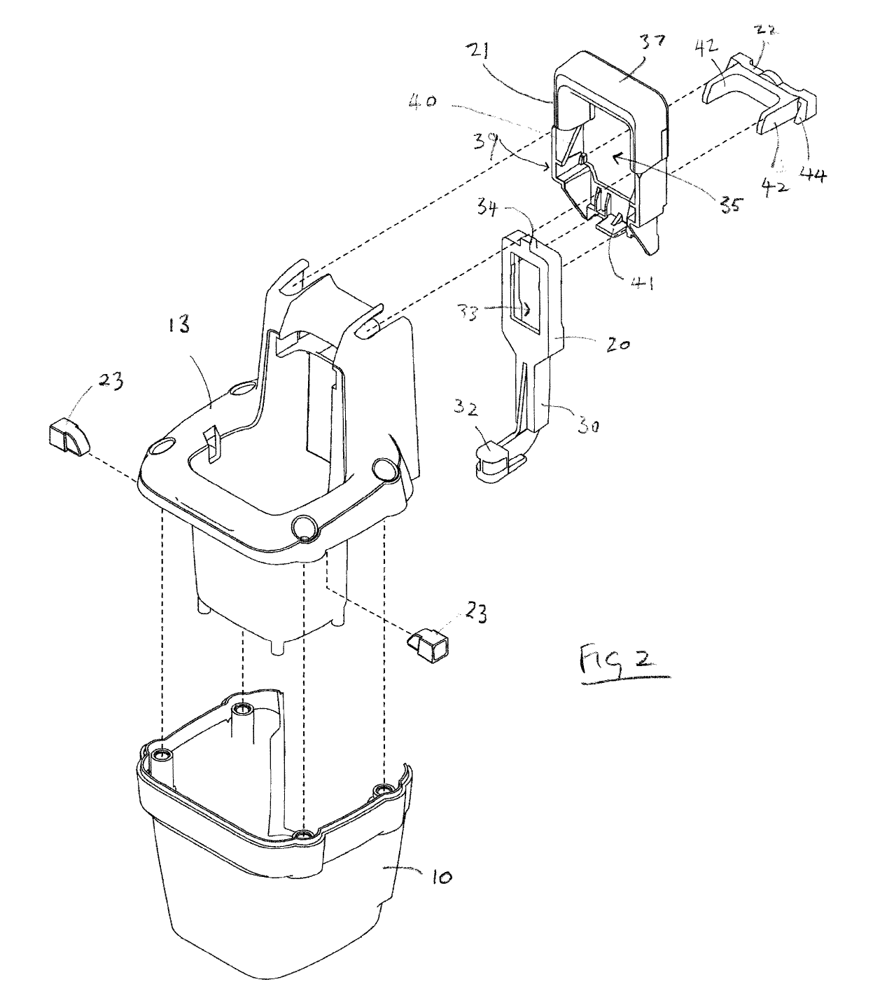

FIG. 2 gives an exploded view of the cradle, showing a locking actuator 20, a locking release actuator 21, and locking latch 22. In this example, the locking actuator and latch are in sliding contact with the release actuator which is in turn mounted in the upper portion of the cradle. A pair of spring loaded locking pins 23 are mounted in the rim 13. These components form a lock and release mechanism which holds the radio or battery securely in the cradle. The components are typically made from plastic and may take a variety of shapes in other embodiments.

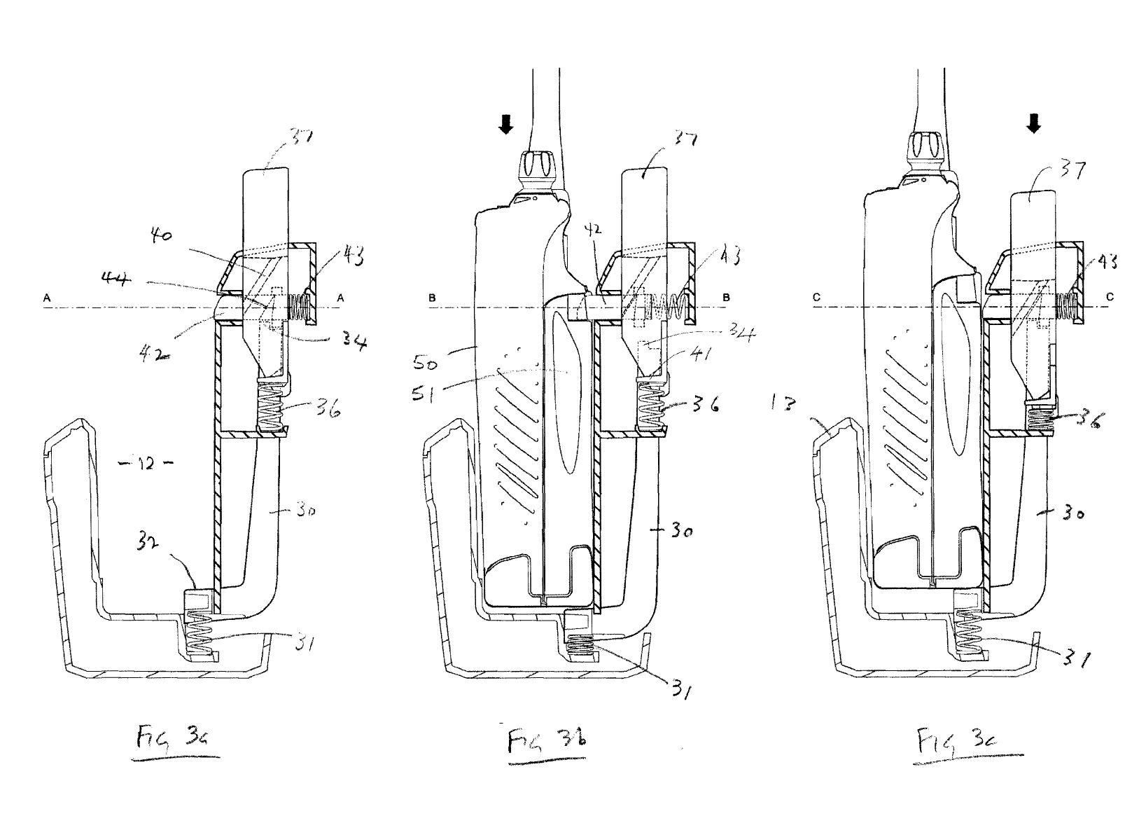

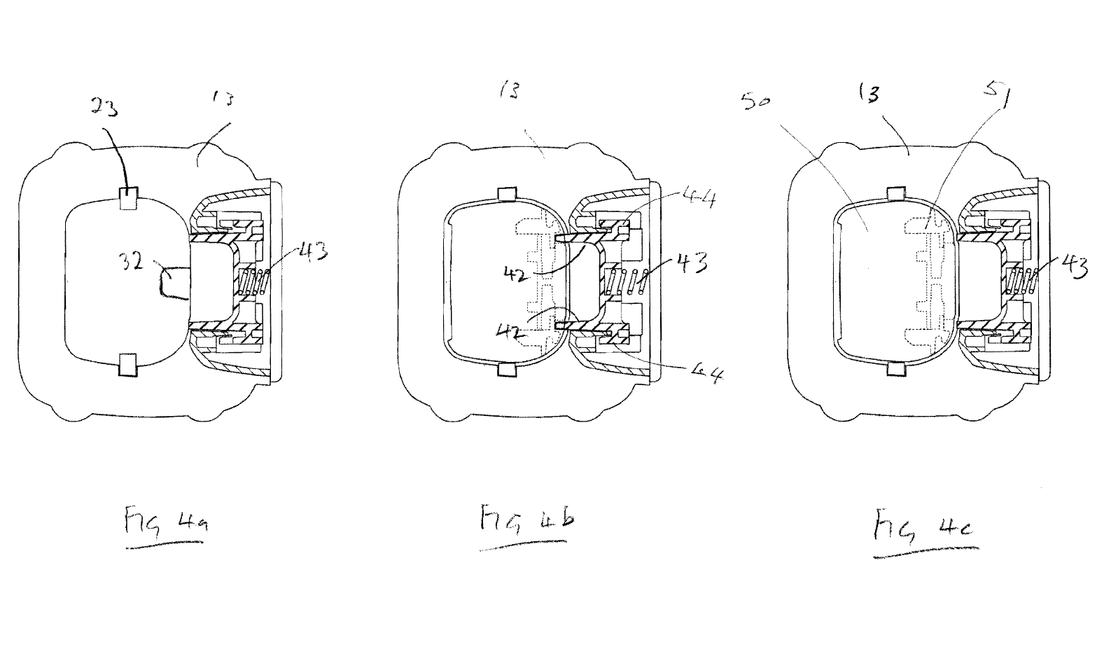

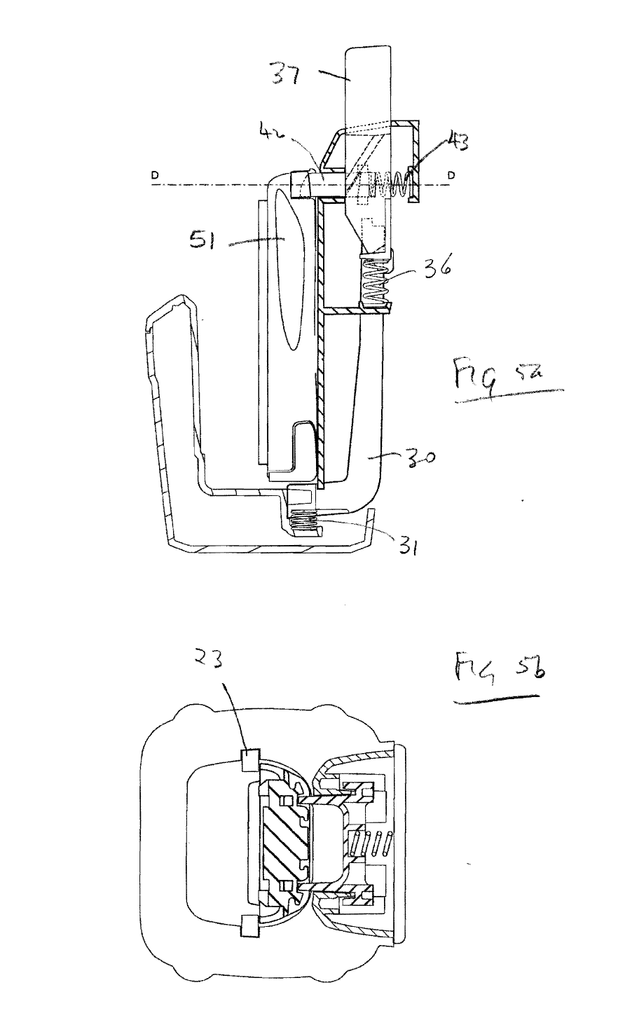

FIGS. 3a, b, c and corresponding FIGS. 4a, b, c indicate how the lock and release mechanism operates in relation to a complete radio 50 including battery 51. FIGS. 5a, b indicate how the lock and release mechanism operates in relation to the battery alone.

The locking actuator 20 has an approximate L shape with a single leg 30, and sits in a vertical orientation within the cradle, biased upwards by a spring 31. A foot 32 on the lower end of the leg lies in the bottom of the upper portion 11 and extends into the recess 12. An aperture 33 towards the upper end of the leg is guided by an internal part on the upper portion 11. A shoulder 34 on the upper end of the leg is shaped to engage the locking latch 22.

The release actuator 21 has an approximately square O shape with a central aperture 35, and sits in a vertical orientation in the upper portion of the cradle, biased upwards by a spring 36. A contact portion 37 protrudes above the cradle. A pair of slots 39 guide the locking latch through the central aperture, and include respective cam surfaces 40. A foot 41 is guided by an aperture in the upper portion 11 and rests on spring 36.

The locking latch 22 is approximately U shaped with a pair of arms 42 and lies in a horizontal orientation through the release actuator 21, biased transversely by a spring 43. The arms are able to slide in slots 39 on the release actuator while a pair of cam surfaces 44 are aligned with corresponding surfaces 40. The ends of arms 42 are shaped to engage corresponding recesses in a battery.

FIGS. 3a and 4a show the empty cradle. Locking actuator 20 is held upwards by spring 31. Shoulder 34 on the locking actuator restrains the locking latch 22 in an open position, against spring 43. The locking release actuator 21 is held upwards in an open position by spring 36. All of the springs are seated on internal surfaces of the cradle as shown.

FIGS. 3b and 4b show a radio 50 including battery 51 locked into the cradle by a user. Locking actuator 20 is displaced downwards in recess 12 against spring 31, by contact of the battery on foot 32. Locking latch 22 has been released by shoulder 34 and is displaced transversely into engagement with the battery by spring 43. The radio generally abuts internal walls of the recess 12 and is biased firmly against arms 42 of the latch by spring 31. Pins 23 have also engaged the battery but are not shown in this view.

FIGS. 3c and 4c show how the radio 50 is released from the cradle. The user applies downwards pressure to contact portion 37 of the locking release 21, against spring 36. Cam surfaces 40 on the release actuator engage cam surfaces 44 on the locking latch 22 which restores the latch to the open position out of engagement with the battery 51. The locking actuator and the radio are returned upwards by spring 31 and shoulder 34 again restrains the latch against spring 43.

The user then removes pressure from the release actuator which returns to the open position, and the radio can be removed from the cradle.

FIGS. 5a and 5b correspond to FIGS. 3b and 4b, and show how the battery 51 is held in the cradle without necessarily being attached to the radio. The locking actuator, locking latch and release actuator behave as before. Pins 23 hold the battery in engagement arms 42 of the latch. Charging of a battery separately from the radio might be considered an optional feature.

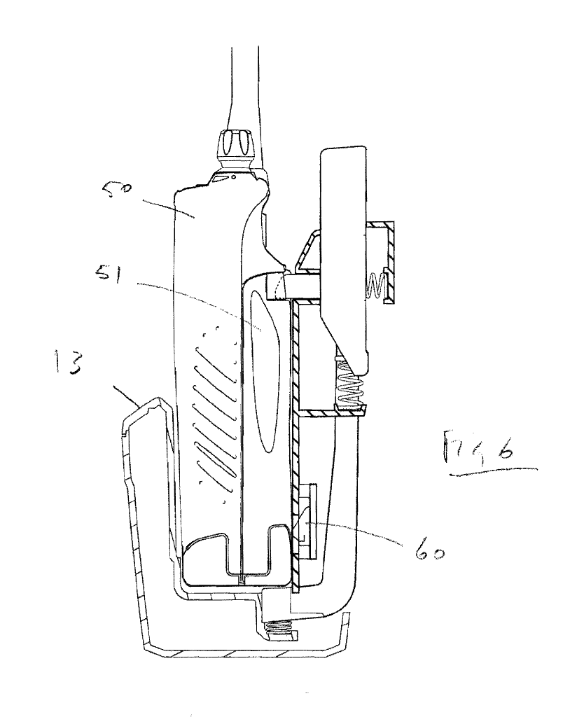

FIG. 6 is a sectional view indicating the location of electrical contacts 60 inside the cradle. These contacts meet corresponding contacts on the battery 51. The associated electrical circuit and connection to an external power supply, typically a vehicle battery, will be known to a skilled reader and have not been shown.

The cradle may be fixed within a vehicle in a variety of ways, depending on surfaces and fittings which are available inside vehicle. A range of brackets may be attached to the rear of the cradle for example. The cradle may also be held in an aperture having edges which are sandwiched between the upper and lower portions 10 and 11.

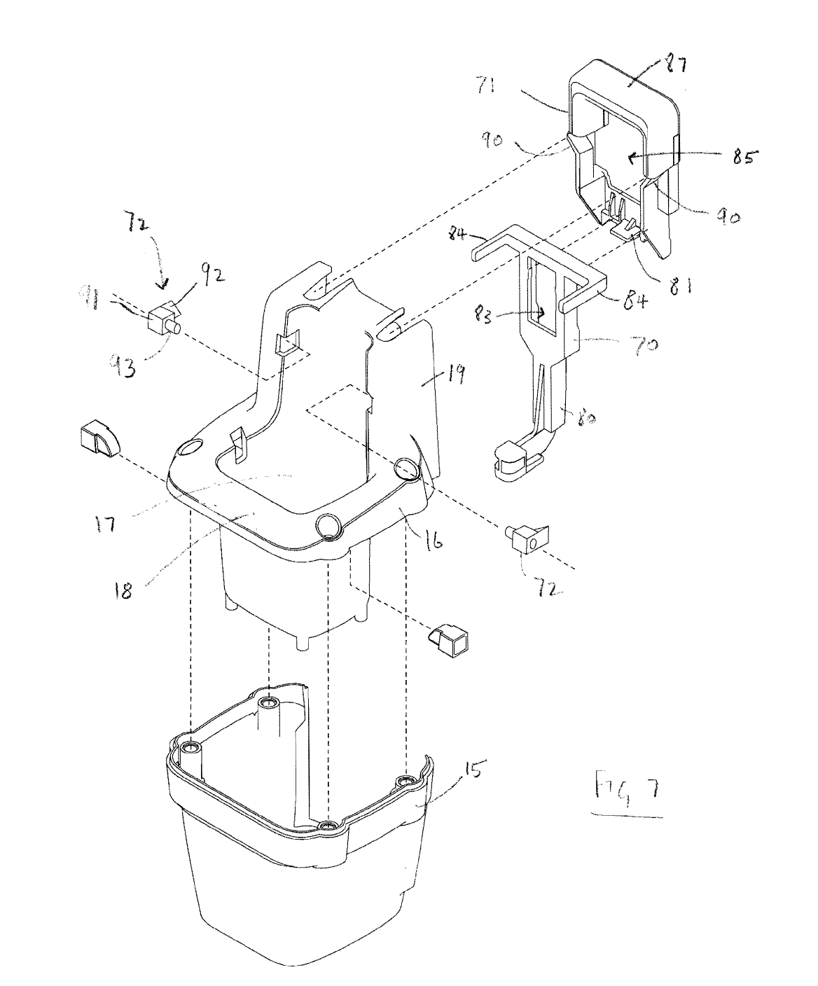

FIG. 7 shows a second embodiment of the battery charger, having a cradle formed by a lower portion 15 and an upper portion 16. The upper portion includes a recess 17 with a rim 18, which receives the base of the radio, or the battery alone, and a rear support 19 which contains all or part of a lock and release mechanism for a rear part of the radio or battery.

The charger in FIG. 7 includes a locking actuator 70, a locking release actuator 71, and a locking latch formed by a pair of pins 72 mounted separately in the upper portion 16. The locking actuator and latch are in sliding contact with the release actuator which is in turn mounted in the upper portion of the cradle. These components form a lock and release mechanism which holds the radio or battery securely in the cradle.

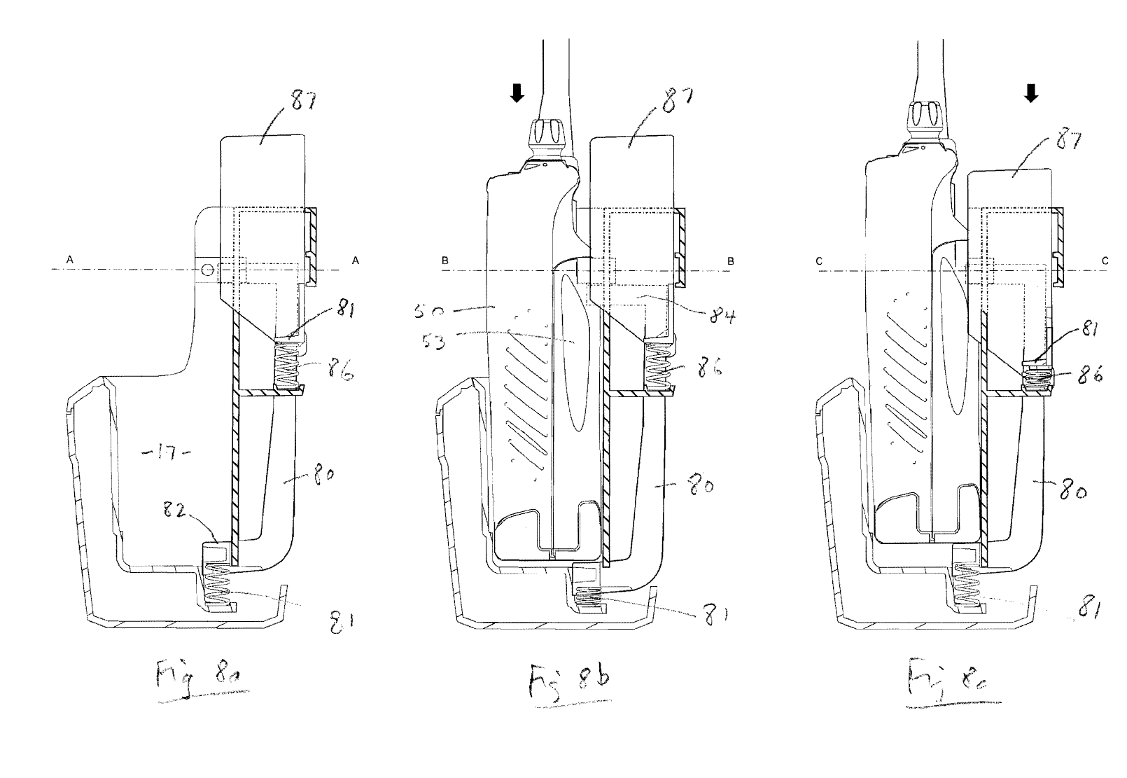

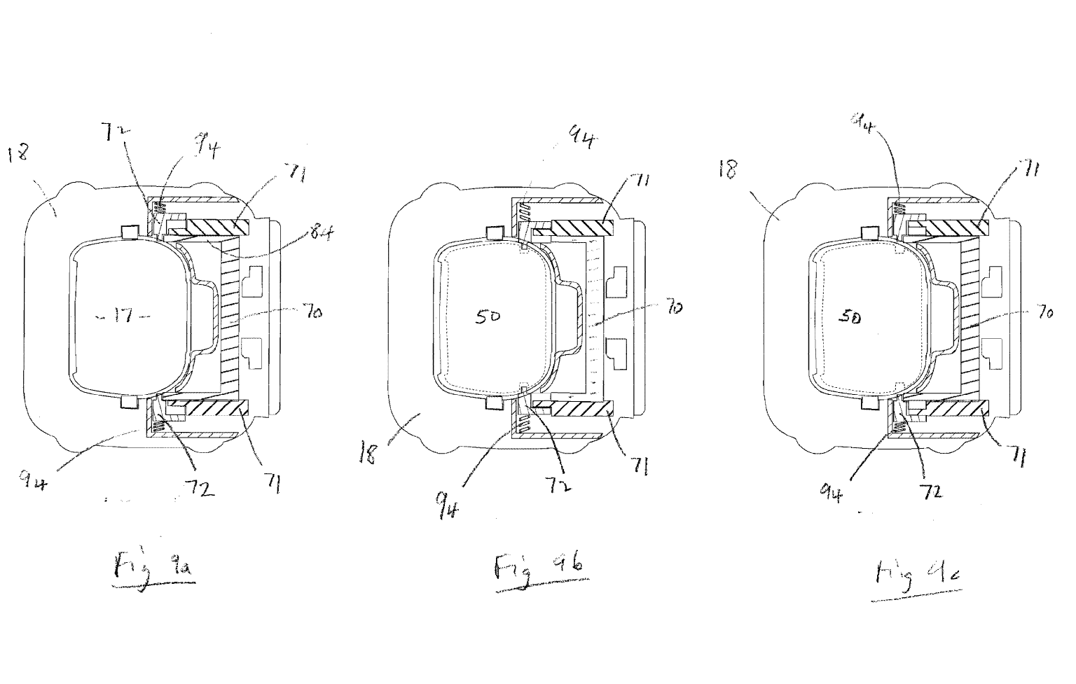

FIGS. 8a, b, c and corresponding FIGS. 9a, b, c indicate how the lock and release mechanism operates in relation to a complete radio 50 including battery 53. The lock and release mechanism may also operate in relation to the battery alone.

The locking actuator 70 has an approximate L-shape with a single leg 80, and sits in a vertical orientation within the cradle, biased upwards by a spring 81. A foot 82 on the lower end of the leg lies in the bottom of the upper portion 16 and extends into the recess 17. An aperture 83 towards the upper end of the leg is guided by an internal part on the upper portion 16. A pair of arms 84 on the upper end of the leg are shaped to interact with the pins 72 of the locking latch.

The release actuator 72 is an approximately square O-shape with a central aperture 85, and sits in a vertical orientation in the upper portion of the cradle, biased upwards by a spring 86. A contact portion 87 protrudes above the cradle. The arms of the locking latch are guided by internal sides of the central aperture 85. Cam surfaces 90 on external sides of the central aperture interact with the pins 72. A foot 81 is guided by an aperture in the upper portion 16 and rests on spring 86.

The locking latch is formed by a pair of separate latches or pins 72 in this example. Each pin has an approximate L-shape which includes a central block 91, a cam surface 92 and a protrusion 93. Each pin lies in a horizontal orientation biased transversely inwards to the cradle by a respective spring 94. The cam surfaces 92 are aligned with corresponding cam surfaces 90 on the release actuator 71. The protrusions 93 engage corresponding recesses in the battery 53.

FIGS. 8a and 9a show the empty cradle. Locking actuator 70 is held upwards by spring 81. Arms 84 restrain the pins of locking latch 72 in an open position, against springs 94. The locking release actuator 71 is held upwards in an open position by spring 86. All of the springs are seated on internal surfaces of the cradle as shown.

FIGS. 8b and 9b show a radio 50 including battery 53 locked into the cradle by a user. Locking actuator 70 is displaced downwards in recess 17 against spring 81, by contact of the battery on foot 82. Locking latch 72 has been released by arms 84 and the pins are displaced transversely into engagement with the battery by springs 94. The radio generally abuts internal walls of the recess 17 and is biased firmly against the latch by spring 81. Other pins provided in the cradle may also engage the battery but are not shown in this view.

FIGS. 8c and 9c show how the radio 50 is released from the cradle. The user applies downwards pressure to contact portion 87 of the locking release 71, against spring 86. Cam surfaces 90 on the release actuator engage cam surfaces 92 on the locking latch 72 which restores the respective pins to the open position out of engagement with the battery 53. The locking actuator and the radio are returned upwards by spring 81 and arms 84 again restrain the pins of latch 72 against springs 94.

The user then removes pressure from the release actuator 71 which returns to the open position, and the radio can be removed from the cradle.

1. A battery charger for a portable radio, including:
a cradle which receives the battery alone or attached to the radio (the battery/radio),
a lock actuator provided in the cradle which is displaced when the battery/radio is pushed into the cradle by a user,
a lock provided in the cradle which engages the battery/radio once the lock actuator has been displaced, and
a release actuator provided in the cradle which is displaced by the user to disengage the lock from the battery/radio, for removal of the battery/radio from the cradle.

2. A charger according to claim 1, wherein the lock actuator includes a foot which is biased upwards in the cradle and onto which the base of the battery/radio is urged downwards by the user.

3. A charger according to claim 2, wherein the lock actuator includes a portion which restrain the lock until the lock actuator is displaced by the base of the battery/radio.

4. A charger according to claim 3 wherein the lock actuator has an approximately L-shaped body with the restraining portion and the foot formed at the upper and lower ends of the body.

5. A charger according to claim 1, wherein the lock is biased transversely in the cradle and is released to engage the battery/radio by downwards displacement of the lock actuator.

6. A charger according to claim 5, wherein the lock includes one or more pins which engage corresponding recesses in the battery/radio.

7. A charger according to claim 6 wherein the lock includes an approximately U-shaped body with a pin formed by each end of the body.

8. A charger according to claim 6 wherein the pins are mounted separately in the cradle.

9. A charger according to claim 1, wherein the release actuator is biased upwards in the cradle and urges the lock transversely away from the battery/radio when pushed downwards by the user.

10. A charger according to claim 9 wherein the release actuator includes one or more cam surfaces which engage corresponding surfaces on the lock to urge the lock away from the battery/radio.

11. A charger according to claim 10 wherein the release actuator includes an approximately O-shaped body with a cam surface provided on each side of the body.

12. A charger according to claim 1 wherein the cradle contains an electrical circuit and electrical contacts through which the battery can be charged.

13. A charger according to claim 1 wherein the lock engages a rear surface of the battery/radio, and the cradle further includes a pair of pins which engage respective side surfaces of the battery/radio.

14. A charger according to claim 1 further including fixtures for mounting the cradle in a vehicle.

15. A battery charger substantially as described with respect to the accompanying drawings.
